(19) United States
(12) Patent Application Publication
(10) Pub. No.: US 2018/0327322 A1
(43) Pub. Date: Nov. 15, 2018

(54) COATING FORMED ON GRAPHITE SUBSTRATE AND METHOD FOR PRODUCING THE SAME

(71) Applicant: NIPPON CARBON CO., LTD., Tokyo (JP)

(72) Inventors: Kazuaki YAMASHITA, Kaga-shi, Ishikawa (JP); Akira URANO, Omihachiman-shi, Shiga (JP)

(73) Assignee: NIPPON CARBON CO., LTD., Tokyo (JP)

(21) Appl. No.: 15/774,886

(22) PCT Filed: Nov. 2, 2016
(86) PCT No.: PCT/JP2016/082703

§ 371 Date: May 9, 2018

(30) Foreign Application Priority Data
Nov. 11, 2015 (JP) 2015-220956

(51) Int. Cl. C04B 35/52; C04B 35/565; C04B 41/87; F16L 59/02; C04B 41/50

(52) U.S. Cl. CPC C04B 35/52; C04B 35/565; C04B 41/87; C04B 2235/658; C04B 41/5059; C04B 2237/385; F16L 59/02

(57) ABSTRACT

A gas impermeabe coating composed of mainly silicon carbide (SiC) without cracks, comprising of a metallic silicon powder as a silicon source, a phenolic resin as a carbon source, a silicon carbide (SiC) powder and solvent are mixed. A mixture is applied to a graphite substrate material, dried and treated in an inert gas atmosphere at temperature from 1500° C. to 2500° C., preferably around 2000° C., with the silicon carbide powder existence in the coating mixture. The metallic silicon powder and carbon constituting the phenolic resin are reacted to form silicon carbide (SiC), thereby a coating film with no cracks is obtained on the graphite substrate material, such as carbon fiber felt molded heat insulation material.

### FIELD OF THE INVENTION

The present invention relates to a coating mainly composed of silicon carbide having low gas permeability and formed on a surface of carbon fiber molded heat insulation materials, carbon fiber reinforced carbon materials, or graphite block, and a method for producing the same.

### BACKGROUND OF THE INVENTION

Carbon has excellent properties in heat resistance, chemical stability and electric conductivity, excellent in shape stability and micro machinability, so it is commonly used in a wide range of industrial fields including general industries, an aerospace aviation industry, and a nuclear industry.

Molded carbon fiber felt bodies are widely used as heat insulation materials for the high temperature furnace, monocrystalline silicon pulling device for semiconductor manufacturing and crystalline silicon manufacturing device for manufacturing solar cell and the like.

Artificial graphite block materials (graphite block materials) including carbon fiber reinforced carbon materials (C/C composite materials) and isotropic graphite are widely used in the aerospace industry in addition to various equipment used in high-temperature furnaces and semiconductor manufacturing processes.

### <Molded Carbon Fiber Felt Heat Insulation Material>

Molded carbon fiber felt heat insulation material has excellent heat resistance property, chemical stability, electric conductivity, and it can withstand high temperatures exceeding 2000° C., so it is suitable for heat insulation in high temperature furnace.

In addition, since the molded carbon fiber felt heat insulation material is excellent in shape stability and can be processed finely, it is used as parts member for a single crystal silicon pulling devices.

Molded carbon fiber felt heat insulation material comprising of compressed fine carbon fiber, likely emits fine fiber dust during handling of the material. When tips of fine carbon fiber are released into the atmosphere inside the furnace, they become contaminants for the high purity products processed in the furnace, which may degrade the quality of the high purity products.

Also, inside the apparatus for manufacturing crystalline silicon, silicon monoxide (SiO) gas or oxygen gas having high activity under high temperature is generated as an impurity gas. This silicon oxide (SiO₂) gas or oxygen gas has high activity, silicon carbide (SiC) is generated when the molded carbon fiber felt heat insulation material and silicon oxide (SiO₂) gas react, and the molded carbon fiber felt heat insulation material and oxygen gas, Oxidized carbons such as carbon monoxide and carbon dioxide are generated.

As the carbon fiber reacts with these gases, the structure of the heat insulation material is collapsed and voids are formed inside the heat insulation material which causes a problem of descending of the heat insulation performance. In order to prevent this reaction, therefore, surface treatment is applied to the carbon fiber molded heat insulation material by forming a gas impermeable coating and thereby to reduce the gas permeability of the heat insulation material.

One of the methods of manufacturing a carbon fiber molded heat insulation material of low gas permeability property is to cover the surface with expanded graphite sheet with adhesives. However, the reactive gas deteriorates the adhesion portion, the expanded graphite sheet goes off from the surface and it becomes difficult to maintain the property of low gas permeability of the material.

In order to solve the above problem, it has been proposed to form a surface treatment layer on the surface of the carbon fiber molded heat insulation material, by covering the surface with a mixture of a thermosetting resin and amorphous carbon aggregates thereby forming a carbon coating with heat treatment.

It is known that there exists a manufacturing method of a silicon carbide coating which has improved properties of oxidation resistance and chemical resistance against silicon oxide (SiO) on the surface of the carbon fiber molded heat insulation material, and is superior to the above mentioned carbon coating. For instance, a conventional method of producing a high durability coating of silicon carbide is a method of chemical vapor deposition (CVD method). However, it is technically very difficult to form a high-density and durable coating film on the surface of the carbon fiber heat insulation material and in addition a productivity of the CVD method is rather low and the cost of production becomes high.

Also, in the method of forming a silicon carbide coating film by reaction sintering method in which silicon and carbon are mixed and subjected to a heat treatment in a condition of higher than 1500° C., and because of the density difference between the raw material and the sintered product of silicon carbide (SiC), there occurs a volume shrinkage and as a result, there exits cracks in the obtained silicon carbide coating and desired sufficient gas impermeability cannot be obtained which might be a great disadvantage.

### <C/C Composite Material>

The C/C composite material has a property of high-strength and high-elasticity carbon material reinforced with carbon fiber, and in addition to the inherent characteristics of the carbon material, it has high specific strength and specific elastic modulus and is lightweight, as a heat durable structural member material, and the application in various fields is expanding also for members of producing crystalline silicon for semiconductors, solar cells, and also for use in the aerospace industry.

However, the C/C composite material has drawbacks of exhaustion by oxygen in an oxidizing atmosphere exceeding 400° C.

Further, inside a manufacturing apparatus such as single crystal silicon or polycrystalline silicon, if the C/C composite material reacts with silicon oxide (SiO) gas or oxygen gas which are impurity gas generated in the manufacturing apparatus, silicon carbide (SiC), or carbon oxides such as carbon monoxide and carbon dioxide are generated same as in the case of molded carbon fiber felt heat insulation material.

For this reason, it has been examined to form a silicon carbide (SiC) coating on the surface of the C/C composite material for providing an anti-oxidation coating. As a method of forming a coating of silicon carbide (SiC) on a C/C composite material, there are well-known methods of forming a silicon carbide coating on the surface of the C/C composite material, a chemical vapor deposition method (CVD method) in which silicon carbide produced by vapor deposition is directly deposited on the surface, a chemical vapor infiltration method (CVI method) in which silicon carbide (SiC) is permeated and precipitated inside the material and a conversion method (CVR method) in which silicon carbide (SiC) is formed by reacting carbon of a substrate with a silicon component.

In any of these methods of forming silicon carbide coating, a target material is placed on a support member in a furnace and processed in the gaseous atmosphere, so it is impossible to form a coating film completely on a surface of the target material with the silicon carbide (SiC) where it comes in contact with the support member. For this reason, it is necessary to conduct a plurality of processes changing the contact positions of the support member and the target material, which requires time and cost. In addition, forming a coating film on a surface of atypical appearance objects, such as crucibles and cylinders, it is difficult to control reactant gas flow in the furnace and it is difficult to form uniform coating. Therefore, it is necessary to change the setting position of the object materials plural times and it takes time changing setting positions of the objects to be treated. The number of objects capable of being processed at one operation is limited to a small number, which raises a processing cost.

### <Graphite Block Material>

Graphite block material is widely used in the industrial field from fundamental industries such as electricity, machinery, metallurgy, etc. to the semiconductor industry, aeronautics, space industry, nuclear power industry and other advanced industry fields because of its properties in good electric conductivity, heat resistance, chemical stability, self-lubricating ability and machinability. Graphite block material is artificial graphite manufactured by a cold isotropic pressure molding process, a molding process or extrusion molding process and used in different industrial fields depending on its characteristics, however, the graphite block material has drawbacks of exhaustion by oxygen in an oxidizing atmosphere exceeding 400° C.

Further, inside a manufacturing apparatus of single crystal silicon or polycrystalline silicon, if the graphite block material reacts with silicon oxide (SiO) gas or oxygen gas which are impurity gases generated inside the manufacturing apparatus, silicon carbide (SiC), or carbon oxides such as carbon monoxide and carbon dioxide are generated same as in the case of C/C composite material.

In the chemical vapor deposition method (CVD method), it is difficult to form a uniform coating unless the target material is a flat plate or other simple shape. In addition, no coating film of silicon carbide is formed where the graphite block contacts with the support when placed in the CVD furnace, and in order to solve this problem, it is necessary to conduct the CVD process a plurality of times changing the portion in contact with the support, therefore it costs much. Further, forming a coating on a surface of atypical appearance objects, such as crucibles and cylinders, it is difficult to control reactant gas flow in the furnace and it is difficult to form uniform thickness of the coating. Therefore, it is necessary to change the setting position of the object materials plural times and it takes time for changing setting positions of the objects to be treated. The number of objects capable of being processed at one operation in the furnace is limited to a small number, which raises the coating process cost same as the case of C/C composite material.

### PRIOR ART DOCUMENTS

### Patent Documents

### [Patent Document 1] Japanese Patent No. 4361636

### [Patent Document 2] Japanese Patent Laid-Open No. 2005-133033

### [Patent Document 3] Japanese Patent No. 5492817

### [Patent Document 4] Japanese Patent No. 5690789

[Patent Document 5] Japanese Patent Laid open No. 2015-44719

### [Patent Document 6] Japanese Patent Laid-Open No. 2000-219584

### [Patent Document 7] Japanese Patent No. 4071919

### [Patent Document 8] Japanese Patent No. 4455895

### Patent Document 9] Japanese Patent No. 3519748

### Patent Document 10] Japanese Patent No. 5737547

### DISCLOSURE OF THE INVENTION

The present invention is a coating mainly composed of low-gas permeability silicon carbide (SiC) formed on the surface of a graphite substrate material such as a molded carbon fiber felt heat insulation material, a C/C composite material, a graphite block material and the like, manufactured by a method of mixture of silicon and carbon is subjected to reactive sintering at higher than 1,500° C. at low cost without generation of cracks.

### SUMMARY OF THE INVENTION

The present invention uses a reactive sintering method for forming a low gas permeability silicon carbide (SiC) coating on the surface of a graphite substrate material such as a carbon fiber felt molded heat insulation material, a C/C composite material, a graphite block material or the like. A metallic silicon powder as a silicon source, a phenolic resin as a carbon source and a silicon carbide (SiC) powder are mixed and diluted with a dispersion solvent to form a coating material. The coating material mixture is applied on a surface of graphite substrate material, such as a carbon fiber molded heat insulation material, a C/C composite material, a graphite block material or the like and dried, and heat-treatment under an inert gas atmosphere at temperature from 1500° C. to 2500° C., preferably around at 2000° C. Under the condition of existence of the silicon carbide powder, the metallic silicon powder reacts with carbon originated from the phenolic is converted to form a silicon carbide (SiC), consequently on the surface of the graphite substrate material, such as a carbon fiber felt molded heat insulation material, a C/C composite material, and a graphite block material or the like, and a coating with no cracks mainly consisting of silicon carbide (SiC) is formed.

More specifically, the mixture of coating material (paint) applied on the surface of the graphite substrate material such as a carbon fiber felt molded heat insulation material, a C/C composite material, a graphite block material or the like, is dried in the air, and then the dispersion solvent such as isopropyl alcohol evaporates and disappears, and a reactive sintering is conducted at temperature from 1500 to 2500° C., preferably at temperature from 1800 to 2200° C.

There is no particular limitation with regard to the particle size distribution and the average particle diameter of the metallic silicon powder which is a silicon source, unless the metallic silicon powder can be dispersed in the dispersion solvent uniformly and the mixture material is applicable uniformly on the surface of the graphite substrate material such as a carbon fiber felt molded heat insulation material, a C/C composite material, a graphite block material or the like.

However, if a large amount of particles of a particle diameter larger than 45 μm are contained therein, a dispersion stability of the mixture of the coating material (paint) obtained by mixing with the dispersion solvent becomes low which is not preferable for handling the mixture while applying thereon and it becomes difficult to form a uniform thickness of coating, therefore much attention should be paid for the particle diameter larger than 45 μm. Also, in general, the average particle diameter of the metallic silicon powder is less than 3 μm, the price becomes high and it is not preferable from the view point of production cost of the silicon carbide coating.

The silicon carbide (SiC) powder used for preventing occurrence of cracks in the formed silicon carbide (SiC) coating produced by reactive sintering is preferably having a maximum particle diameter less than 45 μm, more preferably a diameter of less than 20 μm. If the maximum particle size of the silicon carbide exceeds 45 μm, the dispersion stability of the mixture (paint) decreases same as in the case of the metallic silicon and handling properties becomes bad, a coating process becomes difficult and the uniformity of the thickness of the coating is not preferable.

A mixture of a metallic silicon powder, a phenolic resin and isopropyl alcohol as a diluting and dispersing solvent is coated on a graphite substrate and dried, and then heat treatment higher than 1500° C. under an inert gas atmosphere for the purpose of forming silicon carbide (SiC). As a result of the sintering reaction, the volume of the coating material shrinks theoretically to about 60% because of the density difference between the resultant product of the silicon carbide (SiC) and the raw material of the metallic silicon and the carbon in the skeleton of the phenolic resin. Due to the volumetric shrinkage, problems such as cracks in the coating and warping of the material occur. Therefore, in order to alleviate the problem of volume shrinkage, a silicon carbide (SiC) powder is added as filler to the mixture of the metallic silicon, the phenolic resin and the isopropyl alcohol.

The resin of the carbon source is preferably a phenol resin, but is not limited thereto, but a resin capable of forming a silicon carbide (SiC) by the reactive sintering can be selected. In addition, pitch, mesophase pitch, natural graphite powder, artificial graphite powder can also be used as the carbon source.

A sintering aid additive can be used to promote and to stabilize the sintering process. The sintering aid additive usually has a lower melting point than the material to be sintered and does not react with the material to be sintered. At the time of sintering, as the temperature of the sintering aid coexists with the particles of the material to be sintered, only the sintering aid melts and a liquid phase is formed between the particles to be sintered. The liquid phase attracts particles to be sintered together and densifies by being filled in the gaps between the particles.

The sintering aid of the present invention is selected one or more from aluminum powder, alumina powder, boron powder and boron carbide powder. Alumina powder is particularly desirable from the viewpoints of cost and safety. The average particle diameter of the sintering aid may be less than from 30 to 40 μm which causes no problems to sintering. The amount to be added is 1 to 24 parts by weight, preferably 3 to 12 parts by weight based on 100 parts by weight of the metallic silicon powder.

In preparing the mixture comprising metallic silicon and a carbon source resin and a dispersing solvent, 100 to 240 parts by weight (60% active ingredient) of a liquid phenolic resin as a carbon source is used per 100 parts by weight of metallic silicon powder), 70 to 120 parts by weight of silicon carbide (SiC) powder, 0 to 24 parts by weight of sintering aid and 300 to 1000 parts by weight of dispersing solvent.

When the liquid phenolic resin is less than 100 parts by weight, unreacted silicon remains and it turns to be undesirable dusts. It is not preferable if the liquid phenolic resin is greater than 240 parts by weight, unreacted carbon remains. The excess carbon is attacked by silicon oxide (SiO₂) gas, and is silicified to be fine silicon carbide (SiC) particles, which may be released from the coating.

The silicon carbide (SiC) powder, a certain amount described above added to the coating mixture contributes to the extinction of the cracks and the warp in the coating of the silicon carbide formed on the surface of the graphite substrate material. The sintering aid contributes to decreasing the dust from the coating. The dispersing solvent help the coating mixture being easily applied on the surface of the graphite substrate material by adding the certain amount described above to the liquid phenolic resin which originally contains the dispersing solvent component therein.

Observing the silicon carbide (SiC) coating sintered on the surface of the graphite substrate material with the SEM electron micrograph of FIG. 1, it is found that the silicon carbide (SiC) particles of 5 to 30 μm diameter are sintered to form a coating film. And as a result of analyzing this silicon carbide (SiC) coating by X-ray diffraction, X-ray diffraction peaks of the silicon carbide (SiC) and the carbon coexists. And a peak intensity I_{C} of the carbon showing the (002) plane of the carbon in the vicinity of 2θ of 26°, and a peak intensity I_{SiC} of the silicon carbide (SiC) showing the (111) plane of the silicon carbide (SiC) in the vicinity of 2θ of 35.6°.

According to an analysis of an intensity ratio (I_{C}/I_{SiC0}) and gas impermeability, the intensity ratio (I_{C}/I_{SiC0}) tells us a tendency of the gas impermeability ability, and the silicon carbide coating having an intensity ratio value less than 0.05 exhibits a good gas impermeability.

When the intensity ratio (I_{C}/I_{SiC}) is greater than 0.05, when attacked by silicon oxide (Silo) gas, the silicification of carbon in the coating progresses to produce fine silicon carbide (SiC) which un-preferably goes off from the coating. If an X-ray diffraction peak of the silicon coexists, the silicon dust may occurs, which is not preferable.

### Advantages of the Invention

By adding silicon carbide (SiC) powder for minimizing the volume shrinkage, during the reactive sintering of the metallic silicon and the carbon from the liquid phenol resin, generation of cracks in the formed silicon carbide (SiC) coating.

Consequently, graphite substrate materials such as carbon fiber felt molded heat insulation material, C/C composite material, graphite block material and the like protected by a gas impermeable coating are obtained at low cost.

### BRIEF DESCRIPTION OF THE DRAWINGS

FIG. 1 is a SEM electron micrograph picture of a cross section of Example 1.

FIG. 2 is an X-ray diffraction diagram of Example 1.

FIG. 3 is a picture of Example 3.

FIG. 4 is a picture of comparative Example 3.

FIG. 5 is an X-ray diffraction diagram of Example 8.

FIG. 6 is a SEM electron micrograph picture of the surface of Example 8.

FIG. 7 is a SEM electron micrograph picture of the surface of a silicon carbide coating film by CVD method of comparative Example 8.

### DETAILED DESCRIPTION OF THE INVENTION

### <Particle Size Measurement>

Measurement method of the average particle diameter and particle size distribution of the metallic silicon powder, silicon carbide (SiC) powder, etc. was carried out by using a laser diffraction type particle size distribution measuring apparatus MT3300EX manufactured by Nikkiso Co., Ltd. with addition of a small amount of a surfactant, and the sample was subjected to ultrasonic dispersion. The cumulative curve is obtained assuming that the total volume of the powder subjected to the test is 100%, and the cumulative curve becomes 10, 50, 90, and 95% when accumulated from the small particle diameter side to the large particle diameter side. The particle diameters of the points were D₁₀, D₅₀, D₉₀, D₉₅ (μm), respectively. D₅₀ represents the average particle diameter.

### Example 1

### (1) Substrate Material

A carbon fiber felt molded heat insulation material (trade name: FGM-201, manufactured by Nippon Carbon Co., Ltd.) was used as a graphite substrate and is cut to length 320 mm×width 320 mm×thickness 20 mm.

### (2) Preparation of Coating Mixture (Paint)

224 parts by weight of a liquid phenolic resin (active ingredient: 60%) to 100 parts by weight of metallic silicon powder (D₁₀=6.43 μm, D₅₀=14.8 μm, D₉₀=28.10 μm, D₉₅=33.51 μm) (D₁₀=5.47 μm, D₅₀=8.70 .mu.m, D₉₀=13.24 .mu.m, D₉₅=14.97 μm) and 450 parts by weight of isopropyl alcohol as a dispersion solvent were weighed and mixed in an atmosphere at 25 degree (paint) was prepared.

### (3) Coating Process

A blended mixture (paint) was applied on a surface of molded thermal insulation material with a brush so as to have a coating amount of 300 g/m² on one side of 320 mm long×320 mm wide base material.

### (4) Drying Process

The molded heat insulation material after the coating step was placed in a drying oven and heated at 150° C. for 2 hours to remove volatile matters and dried.

### (5) Sintering Process

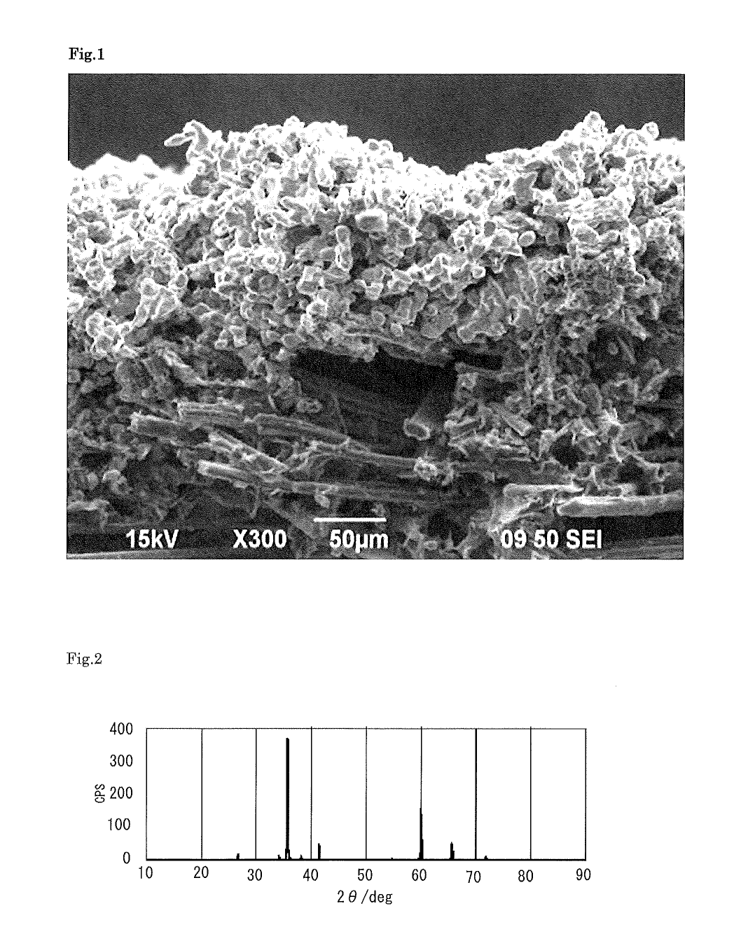

When the molded heat insulation material after the drying step was heat treated at a maximum temperature of 2000° C. under a vacuum inert atmosphere for a holding time of 3 hours, it was confirmed that a coating formed by sintering silicon carbide (SiC) particles of 5 to 30 μm on the surface of the molded heat insulation material. (See FIG. 1)

### Example 2

C/C composite material (trade name CCM-400C, manufactured by Nippon Carbon Co., Ltd.) was cut into 320 mm length×320 mm width×2 mm thickness to obtain a base material. Only one surface of 320 mm length×320 mm width of the base material was coated with 100 g/m 2 (SiC) particles were sintered on the surface of the C/C composite material in the same manner as in Example 1, except that the coating was applied using a brush so as to obtain a coating amount of the C/C composite material.

### Example 3

In the same manner as in Example 2 except that an isotropic graphite material (trade name IGS-743, manufactured by Shin Nippon Technocarbon Co., Ltd.) was cut into a length of 320 mm, a width of 320 mm, and a thickness of 5 mm to form a substrate, And silicon carbide (SiC) particles were sintered on the surface of the isotropic graphite material.

### Comparative Example 1

A carbon fiber molded heat insulation material (trade name FGM-201, manufactured by Nippon Carbon Co., Ltd.) which had been cut to length 320 mm×width 320 mm×thickness 20 mm was used as it was.

### Comparative Example 2

C/C composite material (trade name CCM-400C, manufactured by Nippon Carbon Co., Ltd.) not subjected to surface treatment and cut into 320 mm length×320 mm width×2 mm thickness was used as it was.

### Comparative Example 3

An isotropic graphite material (trade name IGS-743, manufactured by Shin Nippon Technocarbon Co., Ltd.) not subjected to surface treatment and cut to 320 mm length×320 mm width×5 mm thickness was used as it was.

The following is a visual observation result of the properties of the formed coating, and SEM observation result, a gas permeability test result of the coating film, a carbon monoxide exposure test result, and an oxidation depletion test result.

### <Observation Results>

In Examples 1, 2, and 3, a silicon carbide (SiC) coating without cracks was formed on the surface of each graphite substrate material.

### <SEM Observation Result>

SEM image of the cross section of Example 1 is shown in FIG. 1. The thickness of the coating film was about 100 μm in Example 1, about 50 μm in Example 2, about 50 μm in Example 3.

And upon observing the surface of the coating film in each example, a thickness of 5 to 30 μm sintered coating film comprising of silicon carbide (SiC) particles is formed.

### <X-Ray Diffraction Test Results>

For X-ray diffraction, CuKα ray was used by Ultima III system manufactured by Rigaku Corporation, the applied voltage to the X-ray tube was 40 kV, and the current was 20 mA. The scanning speed of the counting tube was measured at 2°/minute and the scanning range was from 10° to 90° at intervals of 0.02°.

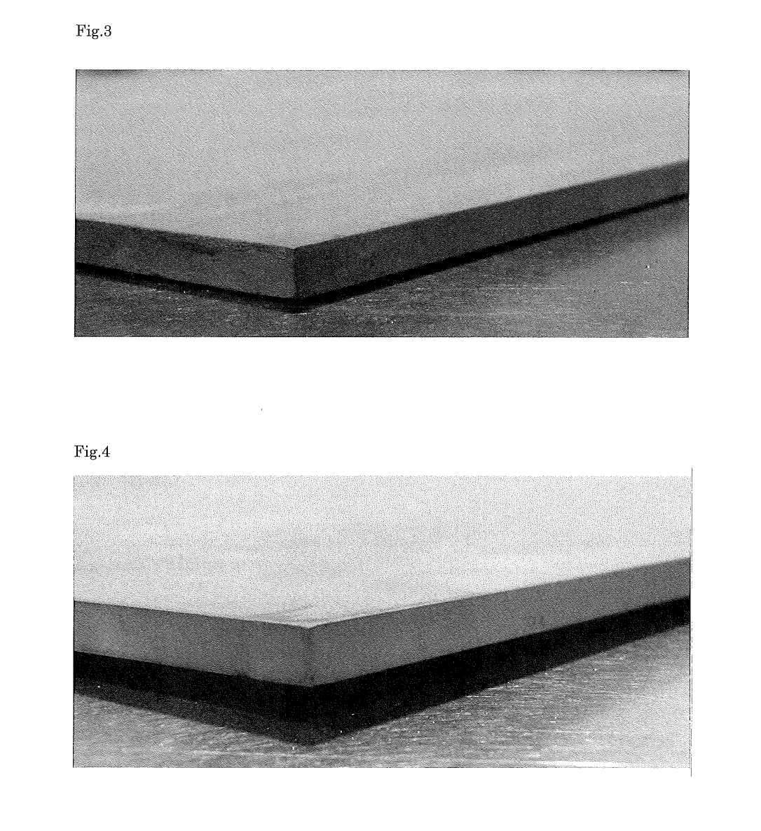

In Examples 1 to 3, as a result of measurement by X-ray diffraction, a peak of (002) plane of carbon appeared near diffraction angle 2θ of 26°, and all others were peaks attributed to silicon carbide (SiC). The X-ray diffraction results of Example 1 are shown in FIG. 2.

The value of the intensity ratio (I_{C}/I_{SiC}) is the value of the intensity of the peak showing the (002) plane of the carbon near the diffraction angle 2θ of 26° and the intensity of the (111) plane of the silicon carbide (SiC) near the diffraction angle 2θ of 35.6° The ratio of the intensities of the peaks representing the planes.

The intensity ratio (I_{C}/I_{SiC}) was 0.04 in all of Examples 1 to 3.

### <Gas Permeability Test Results>

For Examples 1, 2, 3 and Comparative Examples 1, 2, 3, nitrogen gas at a constant pressure was supplied, nitrogen gas passing through the formed coating film of silicon carbide (SiC) was collected and the flow rate of the nitrogen gas was measured. When a single phase fluid flows through the porous body, assuming the flow is a laminar flow and a steady flow, the following Darcy equation holds.

$$k = \frac{q \cdot ρ \cdot x}{A \cdot Δ p} ( {m}^{2} )$$

$$k \text{:} Absolute permeability ( {m}^{2} )$$

$$q \text{:} Flow rate ( {m}^{3} \text{/} s )$$

$$A \text{:} Crossection area of flow ( {m}^{2} )$$

$$p \text{:} Pressure ( Pa )$$

$$μ \text{:} Viscosity of the flow ( Pa \cdot s )$$

$$x \text{:} Thickness ( m )$$

The gas permeability was calculated based on the measured values and the above equation. The viscosity of nitrogen gas was assumed to be 17.4 mPa·s

The calculated results of the gas permeability was 1.8×10⁻¹⁴ m² in Example 1, 1.5×10⁻¹¹ m² in Comparative Example 1, 2.3×10⁻¹⁶ M² in Example 2, and 4.5×10⁻¹⁴ m² in Comparative Example 2, 7.0×2.3×10⁻¹⁷ m² in Example 3.

By forming a silicon carbide (SiC) coating film on various graphite substrates according to the invention of this application, the gas permeability was greatly reduced.

### <Silicon Oxide (SiO₂) Gas Exposure Test Results>

A mixture of metallic silicon powder and silicon dioxide powder stoichiometrically at a ratio of 1:1 was placed in a graphite box-shaped container having an opening of 300 mm×300 mm on one side, and in Examples 1, 2, 3 and Comparative Examples 1, 2, and 3 were placed so that the contents of the graphite container could not be seen with the coated portion facing downward. The sintered coating film portion was exposed to silicon oxide (SiO₂) gas generated when it was heated at 1600° C. under reduced pressure of 10 Pa for 3 hours.

The weight increase rate after the exposure of the silicon oxide (SiO₂) gas was 1.4% in Example 1, 24.7% for Comparative Example 1, 0.2% in Example 2, and 6.9% in Comparative Example 2, 0.1% in Example 3, and 2.2% in comparative Example 3.

In Comparative Examples 1, 2 and 3, the carbon substrate material was silicided by exposure to silicon oxide (SiO₂) gas and apparent weight increase was observed. On the other hand in Examples 1, 2 and 3, weight increase was infinitely small, close to zero. According to the invention of this application, low gas permeability and low anti-silicided properties silicon carbide coating film was formed on the surface of various substrates.

The appearance after the silicon oxide (SiO₂) gas exposure test of Examples 2 and 3 and Comparative Examples 2 and 3 were observed. In comparative Example 2, warpage of about 3 mm occurred due to silicification of the carbon substrate, but warp was not observed in Example 2. In Comparative Example 3, warpage of about 4 mm occurred due to silicification of the carbon substrate, but warp did not occur in Example 3. The appearance of Example 3 and Comparative Example 3 are shown in FIGS. 3 and 4.

### <Oxidation Wear Test Results>

### Example 4

Except that the carbon fiber molded heat insulation material (trade name FGM-201, manufactured by Nippon Carbon Co., Ltd.), cut into a length of 40 mm, a width of 40 mm, and a thickness of 2 mm is used as a substrate, and a coating mixture is applied same manner as example 1, and a carbon fiber felt molded heat insulation material having a silicon carbide (SiC) particles was prepared.

### Example 5

Except that a C/C composite material (trade name CCM-400C, manufactured by Nippon Carbon Co., Ltd.) was cut into a length of 40 mm, a width of 40 mm, and a thickness of 2 mm to be used as a substrate, a coating mixture is applied same manner as example 1, and a coating film obtained by sintering silicon carbide (SiC) particles was obtained on the surface of the C/C composite material.

### Example 6

Except that an isotropic graphite material (trade name IGS-743, manufactured by Shin Nippon Technocarbon Co., Ltd.) was cut into a length of 40 mm, a width of 40 mm, and a thickness of 5 mm to be used as a substrate, a coating mixture is applied same manner as Example 1, and a coating film obtained by sintering silicon carbide (SiC) particles was obtained on the surface of the isotropic graphite material.

### Comparative Example 4

A carbon fiber molded heat insulation material (trade name FGM-201, manufactured by Nippon Carbon Co., Ltd.) which was cut to length 40 mm×width 40 mm×thickness 40 mm was used as comparative example 4 without any surface coating.

### Comparative Example 5

A C/C composite material (trade name CCM-400C, manufactured by Nippon Carbon Co., Ltd.) which is cut into length 40 mm×width 40 mm×thickness 2 mm was used as comparative example 5 without any surface coating.

### Comparative Example 6

An isotropic graphite material (trade name IGS-743, manufactured by Shin Nippon Technocarbon Co., Ltd.) which was cut to length 40 mm×width 40 mm×thickness 5 mm was used as a comparative example 6 without any surface coating.

Examples 4, 5, 6, and Comparative Examples 4, 5 and 6 were exposed to temperature of 1000° C. while flowing dry air at a flow rate of 2 L/min, and the oxidation exhaustion rate was examined.

Oxidation exhaustion rate=[(weight before test−weight after test)/weight of substrate]×100

The time consumed until the oxidation exhaustion rate reached 70% was 180 minutes in Example 4, 50 minutes in Comparative Example 4, 240 minutes in Example 5, 80 minutes in Comparative Example 5, 480 minutes in Example 6 and 130 minutes in Comparative Example 6. With these results, the silicon carbide (SiC) coating formed on various substrates according to the invention of this application contributes greatly as the oxidation resistance coating.

Table 1 shows gas permeability, the weight increase rate before and after the exposure test of the silicon oxide (SiO₂) gas, and the time required until the oxidation consumption rate becomes 70% in the examples and comparative examples.

TABLE 1

| | | Weight insrease | Reqired time |
|---|---|---|---|
| | | rate after | of oxidation |
| | Gas Permiability | gas exposure test | exhaution (70%) |
| | m² | % | min |
| Example 1 | 1.8 × 10⁻¹⁴ | 1.4 | — |
| Example 2 | 2.3 × 10⁻¹⁶ | 0.2 | — |
| Example 3 | 7.0 × 10⁻¹⁷ | 0.1 | — |
| Example 4 | — | — | 180 |
| Example 5 | — | — | 240 |
| Example 6 | — | — | 480 |
| Comparative | 1.5 × 10⁻¹¹ | 24.7 | — |
| Example 1 | | | |
| Comparative | 4.5 × 10⁻¹⁴ | 6.9 | — |
| Example 2 | | | |
| Comparative | 8.5 × 10⁻¹⁵ | 2.2 | — |
| Example 3 | | | |
| Comparative | — | — | 50 |
| Example 4 | | | |
| Comparative | — | — | 80 |
| Example 5 | | | |
| Comparative | — | — | 130 |
| Example 6 | | | |

### Example 7

The metallic silicon powder used in Example 1 was replaced by 100 parts by weight of the pulverized small particle size metallic silicon powder (D₁₀=0.065 μm, D₅₀=0.101 μm, D₉₀=0.158 μm, D₉₅=0.179 μm) and a coating was carried out in the same manner as in Example 1. Comparing the result of the Example 7 with Example 1, even a metallic silicon powder having a small particle size was used, a coating formed by sintering silicon carbide (SiC) particles having a particle diameter of 5 to 30 μm was formed as a result of SEM observation.

From this observation, the silicon carbide (SiC) particle diameter in the coating is not influenced by the particle diameter of the raw material metallic silicon powder in the coating mixture.

### Example 8

C/C composite material (trade name CCM-190C, manufactured by Nippon Carbon Co., Ltd.) was cut into a length of 40 mm, a width of 40 mm, and a thickness of 2 mm to prepare a substrate, and 100 parts by weight of the metallic silicon powder 122 parts by weight of the liquid phenolic resin used in Example 1, 95 parts by weight of silicon carbide (SiC) powder used in Example 1, 12 parts by weight of alumina powder (average particle size: 33.9 μm), isopropyl alcohol 600 parts by weight were respectively weighed and mixed in an atmosphere at 25° C., except that the paint was applied with a brush so that the coating amount of 100 g/m² was only applied to one surface of the substrate having a length of 40 mm×a width of 40 mm, A coating film obtained by sintering silicon carbide (SiC) particles was obtained on the surface of the C/C composite material in the same manner as in Example 1 above.

As a result of measurement by X-ray diffraction, only a peak attributable to silicon carbide (SiC) appeared, and I_{C}/I_{SiC} was 0.00. The X-ray diffraction results are shown in FIG. 5.

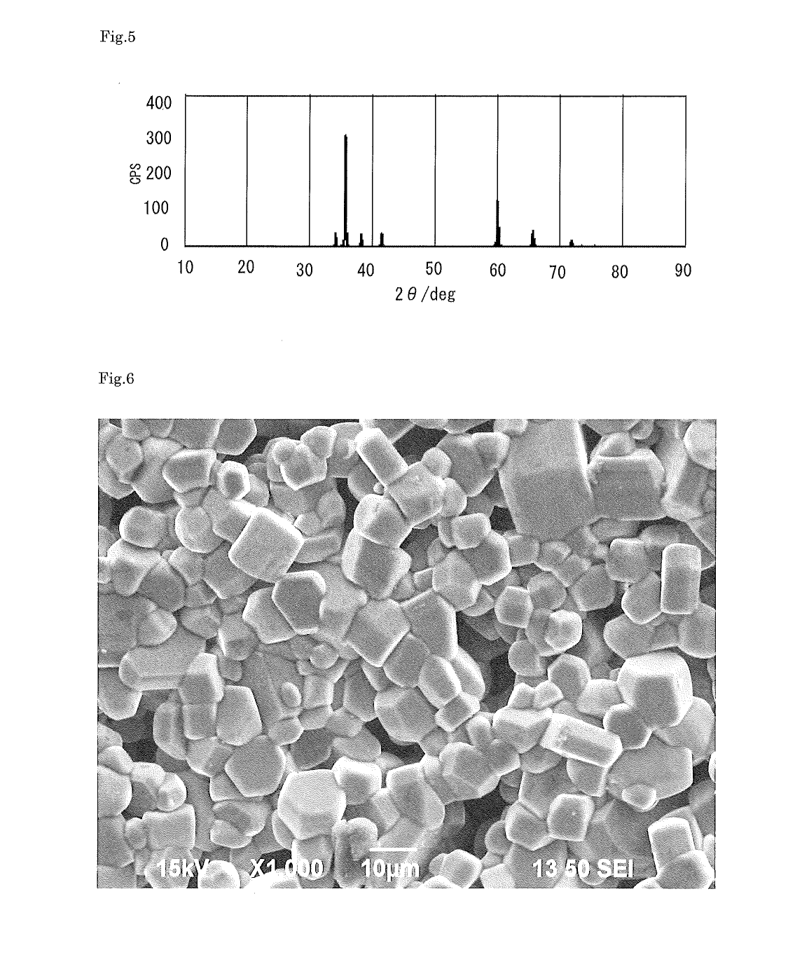

As a result of SEM observation, silicon carbide (SiC) particles of 5 to 30 μm sintered to form a coating film. SEM observation results are shown in FIG. 6.

### Comparative Example 7

C/C composite material (trade name CCM-190C, manufactured by Nippon Carbon Co., Ltd.) was cut into 320 mm length×320 mm width×2 mm thickness to prepare a substrate. In each case, 100 parts by weight of the metallic silicon powder 300 parts by weight of liquid phenolic resin, 95 parts by weight of silicon carbide (SiC) powder and 600 parts by weight of isopropyl alcohol as a dispersing solvent were weighed and mixed in an atmosphere at 25° C., to obtain a mixture (paint) (SiC) particles were sintered in the same manner as in Example 1, except that a coating amount of 100 g/m 2 was applied to only one surface of 40 mm in length×40 mm in width using a brush. Was obtained on the surface of the C/C composite material.

As a result of SEM observation, silicon carbide (SiC) particles of 5 to 30 μm sintered to form a coating film.

As a result of measurement by X-ray diffraction, a peak of (002) plane of carbon appeared near diffraction angle 2θ of 26° except for the peak attributed to silicon carbide (SiC). I_{C}/I_{SiC} were 0.07.

### Comparative Example 8

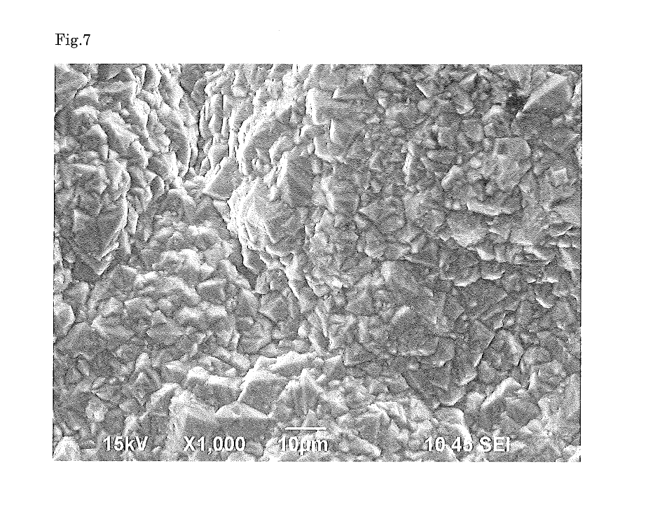

Cut the isotropic graphite material (trade name IGS-743, manufactured by Shin Nippon Technocarbon Co., Ltd.) into a length of 20 mm, a width of 20 mm, and a thickness of 5 mm to prepare a substrate. These were placed in a CVD apparatus, using a mixed gas of SiCl₄ and C₃H₈; a silicon carbide (SiC) coating film was formed on the entire surface of the substrate by the CVD method at a furnace internal pressure of 15 kPa, a treatment temperature of 1300° C., and a treatment time of 3 hours. All the peaks measured by X-ray diffraction were attributed to silicon carbide (SiC). As a result of SEM observation, an aggregate of silicon carbide (SiC) particles of 5 to 30 μm forms a film. The SEM observation results are shown in FIG. 7.

### Comparative Example 9

200 parts by weight of a liquid phenolic resin (active ingredient: 60%), 95 parts by weight of silicon carbide (SiC) powder (maximum particle size: 60 μm), as a dispersing solvent as 100 parts by weight of metallic silicon powder (maximum particle size: 450 parts by weight of isopropyl alcohol were weighed and mixed in an atmosphere at 25° C. to form a coating material, but the particles precipitated and did not become a coating material with good dispersion stability.

It should be noted that the present invention is not limited to the above-described embodiments and can be modified within a scope of the claims of this application.

1. A coating of a graphite substrate material comprising of a sintered silicon carbide (SiC) particles, wherein the diameter of the sintered silicon carbide particle is 5 to 30 μm.

2. The coating comprising of sintered silicon carbide (SiC) particles according to claim 1, wherein X-ray diffraction peaks of silicon carbide (SiC) and carbon are coexistent, and carbon having a diffraction angle 2θ of around 26° an intensity ratio (I_{C}/I_{SiC}) of the intensity I_{C} of the peak showing the (002) plane of the silicon carbide (SiC) having the diffraction angle 2θ of 35.6° and the intensity I_{SiC} of the peak showing the (111) plane of the silicon carbide coating of graphite substrate material is less than 0.05.

3. A method of producing a coating of a graphite substrate material comprise mixing a metallic silicon powder, a phenolic resin as a carbon source, and a silicon carbide (SiC) powder with a solvent thereby forming a mixture, applying the mixture on a surface of a graphite substrate material, and conducting a reactive sintering under an inert gas atmosphere.

4. The method of producing a coating of a graphite substrate material according to claim 3, wherein reactive sintering temperature is between 1500° C. and 2500° C.

5. The method of producing a coating of a graphite substrate material according to claim 3, wherein the reactive sintering temperature is between 800° C. and 2200° C.

6. The method of producing a coating of a graphite substrate according to claim 3, wherein the mixture to be applied on the graphite substrate material comprising of 100 parts by weight of a metallic silicon powder, 60 to 150 parts by weight of a resin serving as a carbon source, 70 to 120 parts by weight of a silicon carbide (SiC) powder, less than 24 part by weight of a sintering aid and 300 to 1000 part by weight of a solvent.

7. The method of producing a coating of a graphite substrate according to claim 6, wherein the sintering aid is one or more selected from aluminum powder, alumina powder, boron powder and boron carbide powder.
